(19) United States
(12) Patent Application Publication
(10) Pub. No.: US 2014/0076172 A1
(43) Pub. Date: Mar. 20, 2014

(54) MECHANICAL COFFEE BREWER FORMED FROM RECYCLED COFFEE BEAN BAG FIBERS

(71) Applicant: Cynthia Bowman, Webster Groves, MO (US)

(72) Inventor: Cynthia Bowman, Webster Groves, MO (US)

(21) Appl. No.: 14/025,906

(22) Filed: Sep. 13, 2013

Related U.S. Application Data
(60) Provisional application No. 61/702,911, filed on Sep. 19, 2012.

(51) Int. Cl. A47J 31/02; B31D 5/00

(52) U.S. Cl. CPC A47J 31/02; B31D 5/00
USPC 99/323; 493/114

(57) ABSTRACT

A mechanical coffee brewer formed from recycled coffee bean bag fibers is provided. The mechanical brewer includes a platform formed from recycled coffee bean bag fibers, wherein the platform has an opening therethrough. A funnel is formed from recycled coffee bean bag fibers and has an open top and a closed bottom. The funnel is secured in the opening in the platform so that the open top is positioned above the platform and the closed bottom is positioned below the platform.

### CROSS-REFERENCE TO RELATED APPLICATIONS

This application is a non-provisional patent application of U.S. Provisional Patent Application Ser. No. 61/702911 filed Sep. 19, 2012 and having the title “MECHANICAL COFFEE BREWER FORMED FROM RECYCLED COFFEE BEAN BAG FIBERS”, which is herein incorporated by reference.

### BACKGROUND OF THE DISCLOSED EMBODIMENTS

The disclosed embodiments include a mechanical coffee brewer, and in particular, a mechanical coffee brewer formed from recycled coffee bean bag fibers.

Known mechanical coffee brewers are generally formed from plastic or metal materials. While these brewers are reusable, they generally require cleaning after each use, thereby creating water and cleaning solution waste. Several brewers have been proposed that are formed from disposable products. Typically, these brewers are formed from cardboard paper products. Additionally, these brewers include openings at the bottom of the brewer. Such openings affect the structural integrity of the brewer when filled with hot water. As such, these brewers are formed from thicker materials and generally result in unnecessary waste. Such waste comes in addition to the waste created by the coffee bean bags in which coffee is delivered. After use, these bags are typically thrown out into a landfill.

A need remains for a product that utilizes the empty coffee bean bags that are generally thrown out. Another need remains for a mechanical brew formed from the recycled coffee bean bag fibers and having a design that accommodates thinner and less wasteful materials in the design. Another need remains for a mechanical brewer that can be decomposed, composted, or recycled.

### SUMMARY OF THE DISCLOSED EMBODIMENTS

In one embodiment, a mechanical coffee brewer formed from recycled coffee bean bag fibers is provided. The mechanical brewer includes a platform formed from recycled coffee bean bag fibers, wherein the platform has an opening therethrough. A funnel is formed from the recycled coffee bean bag fibers and has an open top and a closed bottom. The funnel is secured in the opening in the platform so that the open top is positioned above the platform and the closed bottom is positioned below the platform.

In another embodiment, a method of forming a mechanical coffee brewer is provided, wherein the method includes recycling coffee bean bag fibers into a paper product. A platform is formed from the paper product. A funnel is formed from the paper product, wherein the funnel has a top section and a bottom section. The top section has an open top and the bottom section has a sidewall and a closed bottom. The sidewall includes at least one dispensing aperture extending therethrough. The funnel is secured within an opening in the platform so that the top section is positioned above the platform and the bottom section is positioned below the platform.

In another embodiment, a mechanical coffee brewer formed from recycled coffee bean bag fibers is provided having a platform formed from approximately 50% recycled coffee bean bag fibers and approximately 50% post-consumer recycled materials. The platform has an opening therethrough. A funnel is provided formed from approximately 50% recycled coffee bean bag fibers and approximately 50% post-consumer recycled materials and having an open top and a closed bottom. The funnel is secured in the opening in the platform so that the open top is positioned above the platform and the closed bottom is positioned below the platform.

Further areas of applicability of the disclosed embodiments will become apparent from the detailed description provided hereinafter. It should be understood that the detailed description and specific examples, while indicating the preferred embodiment, are intended for purposes of illustration only and are not intended to limit the scope of the disclosed embodiments.

### BRIEF DESCRIPTION OF THE DRAWINGS

The disclosed embodiments will become more fully understood from the detailed description and the accompanying drawings, wherein:

FIG. 1 is a side schematic view of a mechanical coffee brewer being used with a filter and a coffee mug.

FIG. 2 is a top view of the mechanical coffee brewer.

FIG. 3 is a bottom view of the mechanical coffee brewer.

FIG. 4 is a side view of the bottom section of the mechanical coffee brewer.

FIG. 5 is a flowchart of a method for forming a mechanical coffee brewer from coffee bean bag fibers.

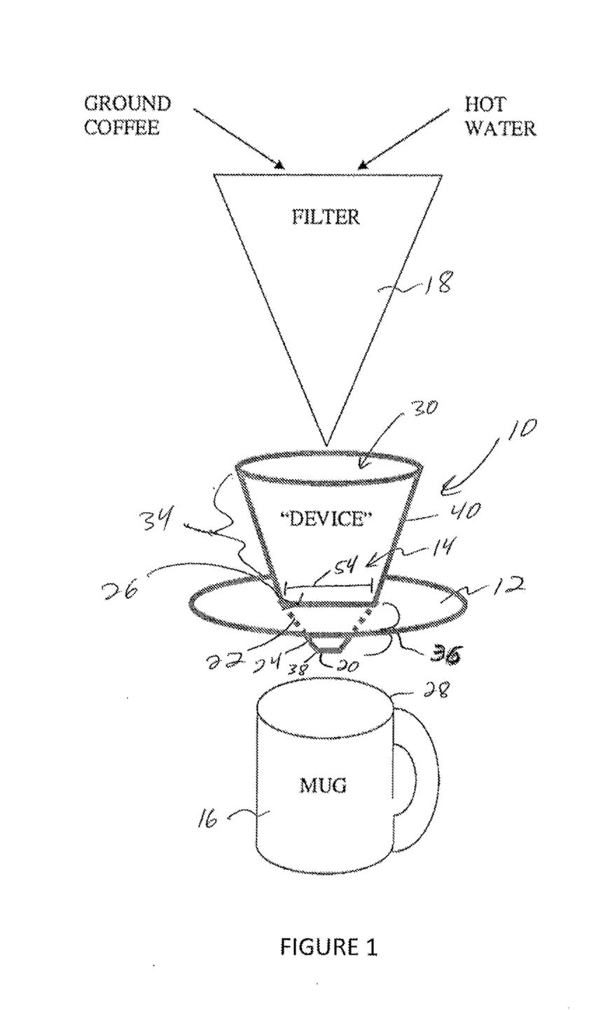

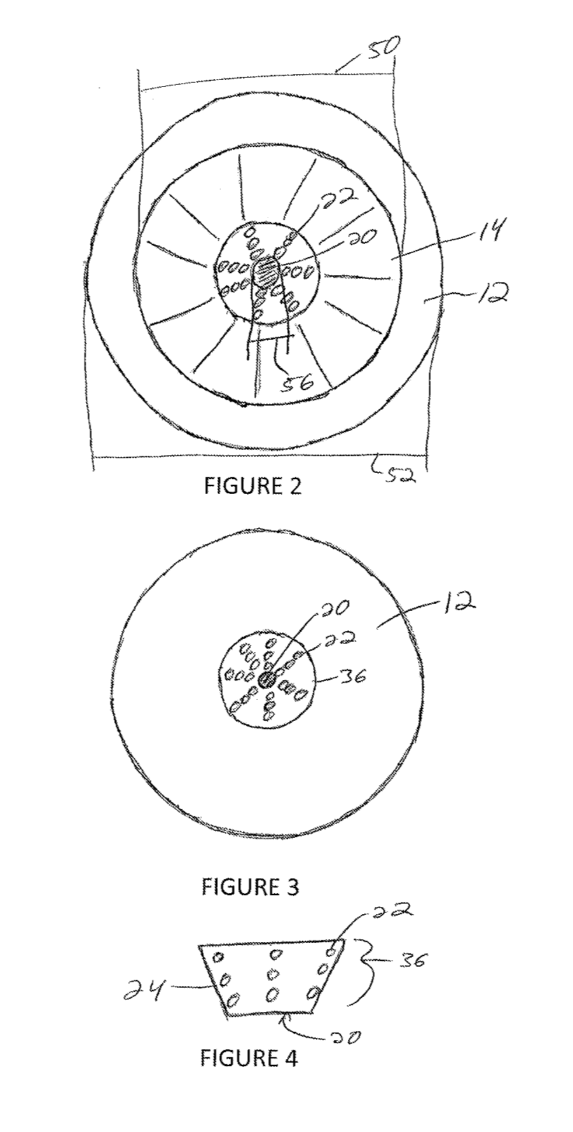

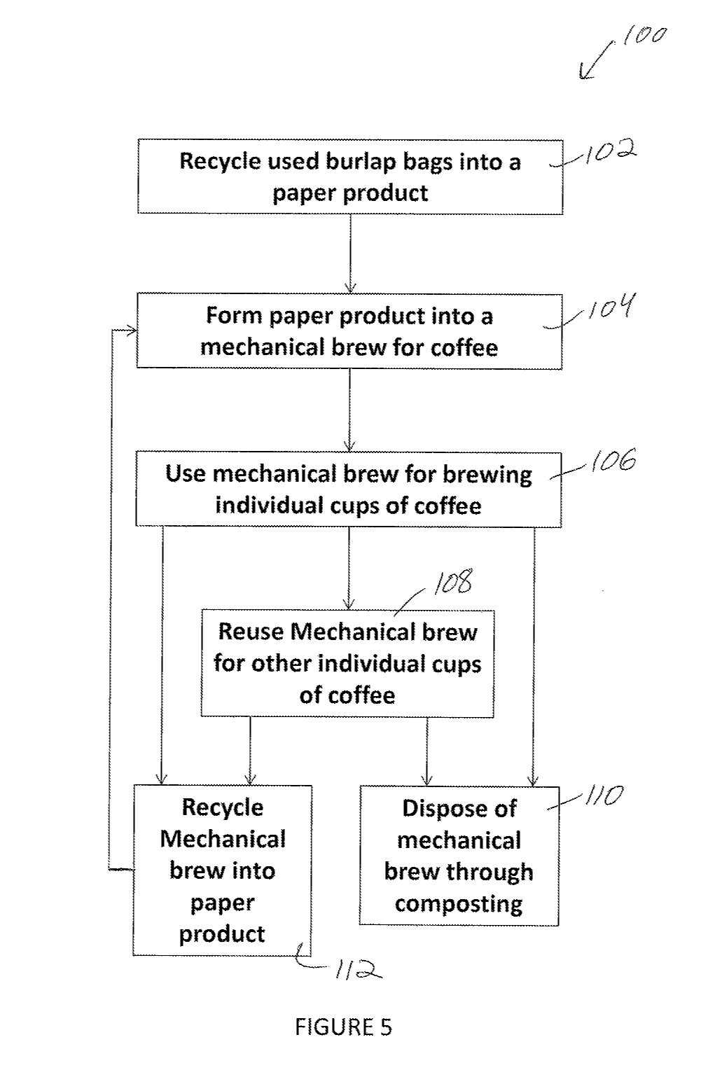

### DETAILED DESCRIPTION OF THE DISCLOSED EMBODIMENTS

The following description of the preferred embodiment(s) is merely exemplary in nature and is in no way intended to limit the disclosed embodiments, their applications, or uses.

The disclosed embodiments provide a mechanical brewer 10 made of paper formed from repurposed coffee bags. In particular, the paper is manufactured from recycled green coffee bags and clean, post-consumer recycled materials. The mechanical brewer 10 is created from the paper to create a platform 12 with a funnel 14 that can be placed on a coffee cup 16, with a filter 18 inserted, and coffee placed in the filter 18. Coffee is brewed directly into the cup 16 by pouring hot (195°-205° Fahrenheit) water over the coffee grounds. The mechanical brewer 10 and soggy coffee grounds can then be composted or recycled. In one embodiment, the mechanical brewer 10 is a single use brewer; however, in other embodiments, the mechanical brewer 10 may be reused.

Mechanical brewers are typically formed from plastic, metal, or glass. However, by utilizing the coffee bean bags the mechanical brewer 10 is decomposable after use. Accordingly, the disclosed embodiments reduce the waste associated with coffee bean bags that are generally thrown out. Also, because the mechanical brewer 10 is decomposable and can be thrown out, the need to clean and wash the mechanical brewer 10 is eliminated. Structurally, the mechanical brewer 10 of the disclosed embodiments includes a closed bottom 20 and at least one dispensing aperture 22 formed in the sidewall 24. As such, the mechanical brewer 10 has increased strength, which enables the mechanical brewer 10 to be formed from thinner materials, thereby further reducing waste.

Although the disclosed embodiments are described with respect to the mechanical brewer 10 being used to brew coffee, it should be appreciated that the mechanical brewer 10 may be used to brew other beverages, such as tea or the like. Additionally, the orientations described herein with respect to the mechanical brewer 10 are described with respect to the mechanical brewer 10 being positioned on a coffee cup 16 for brewing coffee. Accordingly, references to an element being above or below or otherwise oriented with respect to another element are made with respect to the mechanical brewer 10 being positioned upright on the coffee cup or mug 16.

The disclosed embodiments provide a mechanical brewer 10 formed from recycled coffee bean bag fibers, which generally include burlap. The mechanical brewer 10 includes a platform 12 formed from recycled coffee bean bag fibers and having an opening 26 therethrough. The platform 12 is sized to be positioned on the rim 28 of a coffee cup 16. A funnel 14 is formed from recycled coffee bean bag fibers and has an open top 30 and a closed bottom 20. The funnel 14 is secured in the opening 26 in the platform 12 so that the open top 30 is positioned above the platform 12 and the closed bottom 20 is positioned below the platform 12. The funnel 14 is sized to receive a coffee filter 18. The funnel 14 includes a top section 34 positioned above the platform 12 and a bottom section 36 positioned below the platform 12. The open top 30 is formed in the top section 34 and the closed bottom 20 is formed in the bottom section 36. The bottom section 36 includes a sidewall 24 extending downward from the platform 12. The closed bottom 20 is positioned at an end 38 of the sidewall 24 distally from the platform 12. The sidewall 24 includes at least one dispensing aperture 22 extending therethrough to allow water in the funnel 14 to discharge from the funnel 14.

In one embodiment, recycled coffee bean bag fibers are used to form a mechanical brewer 10 that includes the recycled coffee bean bag fibers and post-consumer recycled materials. Typically, the coffee bean bag fibers include burlap fibers. The mechanical brewer 10 may include approximately 50% recycled coffee bean bag fibers and approximately 50% post-consumer recycled materials. The closed bottom 20 of the funnel 14 substantially prevents the mechanical brewer 10 from tearing when the funnel 14 is filled with hot water having a temperature of approximately 195° to 205° Fahrenheit. In an exemplary embodiment, the mechanical brewer 10 is at least one of decomposable, compostable or recyclable.

As illustrated, the platform 12 is circular and includes an opening 26 centered therein. It should be noted that the platform 12 may have any shape that is sized to rest on the rim of a coffee cup or mug 16. The platform 12 is generally flat and configured to rest on the coffee mug 16 so that the platform 12 is positioned horizontally and the funnel 14 extends vertically from the mug.

The opening 26 in the platform 12 is generally circular, but may have any shape suitable for receiving the funnel 14 therein. In the illustrated embodiment, the funnel 14 has a conical shape so the platform 12 has a complementary circular opening 26. In other embodiments, the funnel 14 may have a pyramidal shape, an oval shape, or any other shape suitable for holding a coffee filter 18. In such an embodiment, the opening 26 in the platform 12 is shaped to complement the shape of the funnel 14. In one embodiment, the platform 12 and the funnel 14 are formed from separate blanks and the funnel 14 is secured into the platform 12 with an adhesive, through friction, or the like. The funnel 14 and the platform 12 may also be packaged as separate components that are positioned together when the mechanical brewer 10 is used. In another embodiment, the funnel 14 and the platform 12 may be formed from the same paper blank. In one embodiment, the funnel 14 and the platform 12 are formed to be collapsible, so that the mechanical brewer 10 is collapsed into a storage position. Upon use, the mechanical brewer 10 is folded into an operational position as shown in the Figures.

The funnel 14 includes a conical shape having an open end 30 at the top. As set forth above, the funnel 14 may have any shape suitable for holding a coffee filter 18. The coffee filter 18 is configured to position in the funnel 14 so that the filter rests on the sidewall 24 of the funnel 14. In the illustrated embodiments, the funnel 14 includes a top section 34 and a bottom section 36. In particular, the top section 34 extends above the platform 12, and the bottom section 36 extends below the platform 12. As such, the top section 34 is positioned outside of the coffee mug 16. The open top 30 is formed at the top of the top section 34. The top section 34 has a generally conical shape from the open top 30 to the platform 12. In the illustrated embodiment, the open top 30 of the funnel 14 has a diameter 50 that is less than the diameter 52 of the platform 12, but greater than the diameter 54 of the opening 26 in the platform 12. In other embodiments, the funnel 14 may flare outward so that the diameter 50 of the open top 30 is greater than the diameter 52 of the platform 12.

The bottom section 36 is formed integrally with the top section 34 and extends below the platform 12. The bottom section 36 is configured to be positioned within the mug 16 when the mechanical brewer 10 is positioned on the rim of the mug 16. The bottom section 36 also has a generally conical shape; however, the sidewall 24 of the bottom section 36 is angled more towards a centerline 60 of the funnel 14 than the sidewall 40 of the top section 34. As such, the bottom section 36 angles inward at a greater angle than the top section 34. The bottom section 36 is terminated at a closed bottom 20 formed distally from the platform 12 and extending between the sidewall 24 of the bottom section 36. The closed bottom 20 has a diameter 56 that is less than the diameter 54 of the opening 26 in the platform 12. In other embodiments, the sidewall 24 of the bottom section 36 may extend substantially perpendicular from the platform 12 and the closed bottom 20 may have a diameter 56 that is substantially equal to the diameter 54 of the opening 26 in the platform 12. The closed bottom 20 provides structural integrity to the funnel so that the funnel 14 does not tear, rip, or otherwise break when filled with coffee grounds and hot water.

Dispensing apertures 22 are formed in the sidewall 24 of the bottom section 20. The dispensing apertures 22 allow brewed coffee to pass through the funnel 14 into the mug 16. The dispensing apertures 22 are sized and spaced to provide sufficient brewing, while maintaining the structural integrity of the funnel 14. The dispensing apertures 22 are arranged in rows extending along the sidewall 24 from the closed bottom 20 to the platform 12. The dispensing apertures 22 are not limited to being arranged in rows and other orientations of the dispensing apertures 22 may be utilized with the mechanical brewer 10.

The disclosed embodiments also provide a method 100 of forming a mechanical brewer 10, wherein the method 100 includes the step 102 of recycling coffee bean bag fibers into a paper product. A platform and a funnel are formed from the paper product at step 104. The funnel has a top section and a bottom section. The top section has an open top, and the bottom section has a sidewall and a closed bottom. The sidewall includes at least one dispensing aperture extending therethrough. The funnel is secured within an opening in the platform so that the top section is positioned above the platform and the bottom section is positioned below the platform. In one embodiment, the paper product is formed from recycled coffee bean bag fibers and post-consumer recycled materials. For example, the paper product may be formed from approximately 50% recycled coffee bean bag fibers and approximately 50% post-consumer recycled materials. Typically, the coffee bean bag fibers include burlap. The platform and funnel may be formed integrally or, optionally, the platform and the funnel may be formed as separate pieces that are joined together during manufacturing or prior to use of the mechanical brewer.

During use, at step 106, the mechanical brewer is positioned on the coffee mug so that the platform rests on the rim of the mug. The bottom section of the funnel extends into the mug and the top section of the funnel extends away from the mug. When the platform is positioned on a level coffee mug, the platform is generally horizontal and the funnel extends generally vertically, i.e. an axis of the funnel extends generally vertically. A coffee filter is positioned in the funnel and coffee grounds are disposed in the coffee filter.

Hot water, i.e. water having a temperature of approximately 195° to 205° Fahrenheit is poured over the coffee grounds in the filter. The water sits in the funnel and brews the coffee. The closed bottom of the funnel facilitates preventing the hot water from damaging the structural integrity of the funnel and tearing an opening in the bottom of the funnel. The dispensing apertures are sized to slowly allow the brewed coffee to drip from the mechanical brewer and into the coffee mug. In particular, the dispensing apertures are sized to control a flow of the coffee from the mechanical brewer. The dispensing apertures dispense the coffee at a rate that allows the hot water to sit in the funnel for an appropriate time to brew the coffee before being discharged into the mug.

After the hot water fully discharges into the mug as brewed coffee, the mechanical brewer may be reused, at step 108, for other cups of coffee until the mechanical brewer is too saturated with water for reuse. Alternatively, the mechanical brewer may be disposed of, at step 110, after a single use. Both the mechanical brewer and the coffee grounds may be composted. Alternatively, the mechanical brewer may be thrown out to decompose. In yet another embodiment, the mechanical brewer may be recycled again and used with a paper product that is formed into yet another mechanical brewer, at step 112.

Accordingly, the disclosed embodiments are decomposable, compostable, or recyclable after use. Moreover, the disclosed embodiments reduce the waste associated with coffee bean bags that are generally thrown out and eliminates the need to clean and wash the mechanical brewer. Structurally, the mechanical brewer has increased strength in comparison to the prior art, which enables the mechanical brewer to be formed from thinner materials, thereby further reducing waste.

The embodiments were chosen and described to best explain the principles of the disclosed embodiments and its practical application to persons who are skilled in the art. As various modifications could be made to the exemplary embodiments, as described above with reference to the corresponding illustrations, without departing from the scope of the disclosed embodiments, it is intended that all matter contained in the foregoing description and shown in the accompanying drawings shall be interpreted as illustrative rather than limiting. Thus, the breadth and scope of the present disclosed embodiments should not be limited by any of the above-described exemplary embodiments, but should be defined only in accordance with the following claims appended hereto and their equivalents.

What is claimed is:

1. A mechanical coffee brewer formed from recycled coffee bean bag fibers comprising:
a platform formed from recycled coffee bean bag fibers, the platform having an opening therethrough; and
a funnel formed from recycled coffee bean bag fibers and having an open top and a closed bottom, the funnel secured in the opening in the platform so that the open top is positioned above the platform and the closed bottom is positioned below the platform.

2. The mechanical coffee brewer of claim 1, wherein the funnel further comprises a top section positioned above the platform and a bottom section positioned below the platform, the open top formed in the top section and the closed bottom formed in the bottom section.

3. The mechanical coffee brewer of claim 2, wherein the bottom section includes a sidewall extending downward from the platform, the closed bottom positioned at an end of the sidewall distally from the platform, the sidewall including at least one dispensing aperture extending therethrough to allow water in the funnel to discharge from the funnel.

4. The mechanical coffee brewer of claim 1, wherein the closed bottom of the funnel facilitates preventing the paper product from tearing when the funnel is filled with water.

5. The mechanical coffee brewer of claim 1, wherein the platform is sized to be positioned on the rim of a coffee cup, and the funnel is sized to receive a coffee filter.

6. The mechanical coffee brewer of claim 1, wherein the mechanical coffee brewer is at least one of compostable, decomposable, or recyclable.

7. The mechanical coffee brewer of claim 1, wherein the mechanical coffee brewer is a paper product having post-consumer recycled materials.

8. The mechanical coffee brewer of claim 7, wherein the paper product includes approximately 50% recycled coffee bean bag fibers and approximately 50% post-consumer recycled materials.

9. The mechanical coffee brewer of claim 8, wherein the coffee bean bag fibers include burlap fibers.

10. A method of forming a mechanical coffee brewer comprising:
recycling coffee bean bag fibers into a paper product;
forming a platform from the paper product;
forming a funnel from the paper product, the funnel having a top section and a bottom section, the top section having an open top and the bottom section having a sidewall and a closed bottom, the sidewall including at least one dispensing aperture extending therethrough; and
securing the funnel within an opening in the platform so that the top section is positioned above the platform and the bottom section is positioned below the platform.

11. The method of claim 10 further comprising forming the paper product from post-consumer recycled materials.

12. The method of claim 11 further comprising forming the paper product from approximately 50% recycled coffee bean bag fibers and approximately 50% post-consumer recycled materials.

13. The method of claim 12, wherein the coffee bean bag fibers include burlap fibers.

14. The method of claim 10 further comprising forming the bottom section with a sidewall extending downward from the platform so that the closed bottom is positioned at an end of the sidewall distally from the platform.

15. The method of claim 14 further comprising forming at least one dispensing aperture extending through the sidewall to allow water in the funnel to discharge from the funnel.

16. The method of claim 10 further comprising forming the closed bottom of the funnel to facilitate preventing the paper product from tearing when the funnel is filled with water.

17. The method of claim 10 further comprising sizing the platform to be positioned on the rim of a coffee cup, and sizing the funnel to receive a coffee filter.

18. The method of claim 10 further comprising forming the mechanical coffee brewer to be at least one of compostable, decomposable, or recyclable.

19. A mechanical coffee brewer formed from recycled coffee bean bag fibers comprising:
a platform formed from approximately 50% recycled coffee bean bag fibers and approximately 50% post-consumer recycled materials, the platform having an opening therethrough; and
a funnel formed from approximately 50% recycled coffee bean bag fibers and approximately 50% post-consumer recycled materials and having an open top and a closed bottom, the funnel secured in the opening in the platform so that the open top is positioned above the platform and the closed bottom is positioned below the platform.

20. The mechanical coffee brewer of claim 19, wherein the coffee bean bag fibers include burlap fibers.
